(19) United States
(12) Patent Application Publication
(10) Pub. No.: US 2024/0429401 A1
(43) Pub. Date: Dec. 26, 2024

(54) WIRE MESH CURRENT COLLECTORS FOR ELECTRODES OF BATTERY CELLS WITH INCREASED JOINT CONTACT AND REDUCED RESISTANCE

(71) Applicant: GM GLOBAL TECHNOLOGY OPERATIONS LLC, Detroit, MI (US)

(72) Inventors: Sayed Youssef Sayed NAGY, Troy, MI (US); Anil K. SACHDEV, Rochester Hills, MI (US); Diptak BHATTACHARYA, Royal Oak, MI (US)

(21) Appl. No.: 18/338,554

(22) Filed: Jun. 21, 2023

(51) Int. Cl. H01M 4/74; H01M 4/04; H01M 4/66

(52) U.S. Cl. CPC H01M 4/74; H01M 4/0404; H01M 4/0471; H01M 4/661

(57) ABSTRACT

A method for manufacturing a current collector for an electrode of a battery cell includes providing a wire mesh current collector including a plurality of first wires and a plurality of second wires that overlap to form a plurality of mesh joints. A diameter of the plurality of first wires and the plurality of second wires is in a range from 4 μm to 100 μm. The method includes coating the wire mesh current collector with a metal coating by immersing the wire mesh current collector in a bath including a metal salt.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to wire mesh current collectors for electrodes of battery cells, and more particularly to a method for coating wire mesh current collectors of battery cells to increase joint contact and reduce resistance.

Electric vehicles (EVs) such as battery electric vehicles (BEVs), hybrid vehicles, and/or fuel cell vehicles include one or more electric machines and a battery system including one or more battery cells, modules and/or packs. A battery control module is used to control charging and/or discharging of the battery system during charging and/or driving. Manufacturers of EVs are pursuing increased power density to increase the range of the EVs.

### SUMMARY

A method for manufacturing a current collector for an electrode of a battery cell includes providing a wire mesh current collector including a plurality of first wires and a plurality of second wires that overlap to form a plurality of mesh joints. A diameter of the plurality of first wires and the plurality of second wires is in a range from 4 μm to 100 μm. The method includes coating the wire mesh current collector with a metal coating by immersing the wire mesh current collector in a bath including a metal salt.

In other features, the plurality of first wires and the plurality of second wires of the wire mesh current collector are made of one or more metals selected from a group consisting of copper, stainless steel, brass, bronze, zinc, aluminum, and alloys thereof. The metal coating includes a metal selected from a group consisting of indium (In), tin (Sn), bismuth (Bi), zinc (Zn), nickel (Ni), and alloys thereof.

In other features, the method includes annealing the wire mesh current collector after coating the wire mesh current collector to increase physical and electrical contact at the plurality of mesh joints. The annealing is performed at a temperature greater than a melting temperature of a metal of the metal coating and less than a melting temperature of a metal of the plurality of first wires and the plurality of second wires of the wire mesh current collector.

In other features, the method includes arranging an anode active material layer adjacent to the wire mesh current collector. The method includes arranging a cathode active material layer adjacent to the wire mesh current collector. The method includes coating the wire mesh current collector with a slurry including anode active material. The method includes coating the wire mesh current collector with a slurry including cathode active material.

In other features, the wire mesh current collector is immersed in the bath in discrete sections. The wire mesh current collector is continuously immersed in the bath from a roll.

A method for manufacturing a current collector for an electrode of a battery cell includes providing a wire mesh current collector including a plurality of first wires and a plurality of second wires that overlap to form mesh joints. A diameter of the plurality of first wires and the plurality of second wires is in a range from 4 μm to 100 μm. The plurality of first wires and the plurality of second wires of the wire mesh current collector are made of a metal selected from a group consisting of copper, stainless steel, brass, bronze, zinc, aluminum, and alloys thereof. The method includes immersing the wire mesh current collector in a bath including a metal salt to coat the wire mesh current collector. The metal salt includes a metal selected from a group consisting of indium (In), tin (Sn), bismuth (Bi), zinc (Zn), and alloys thereof. The method includes annealing the wire mesh current collector after passing the wire mesh current collector through the bath.

In other features, the annealing is performed at a temperature greater than a melting temperature of a metal in the metal salt and less than a melting temperature of the metal used in the wire mesh current collector. The method includes arranging an anode active material layer adjacent to the wire mesh current collector. The method includes arranging a cathode active material layer adjacent to the wire mesh current collector. The method includes coating the wire mesh current collector with a slurry including anode active material. The method includes coating the wire mesh current collector with a slurry including cathode active material.

In other features, the wire mesh current collector is immersed in the bath in discrete sections. The wire mesh current collector is continuously immersed in the bath from a roll.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a side cross-sectional view of an example of a battery cell including electrodes with coated wire mesh current collectors according to the present disclosure;

FIGS. 2A and 2B are plan views illustrating tensile strength of an uncoated wire mesh current collector in two directions;

FIGS. 3A and 3B illustrate examples of methods for coating and optionally annealing a wire mesh current collector according to the present disclosure;

FIG. 4A is a side view illustrating an example of the wire mesh current collector after coating according to the present disclosure;

FIG. 4B is an enlarged side view illustrating an example of the wire mesh current collector after coating according to the present disclosure;

FIG. 5A is a side view illustrating an example of the wire mesh current collector after coating and annealing according to the present disclosure; and

FIG. 5B is an enlarged side view illustrating an example of the wire mesh current collector after coating and annealing.

In the drawings, reference numbers may be reused to identify similar and/or identical elements.

### DETAILED DESCRIPTION

While wire mesh current collectors for battery cells according to the present disclosure are described herein in the context of electric vehicles, the battery cells can be used in stationary applications and/or in other types of applications.

Battery cells include anode electrodes, cathode electrodes, and separators arranged in a stack in a predetermined order. The anode electrodes include an anode active layer arranged on one or both sides of an anode current collector. The cathode electrodes include a cathode active layer arranged on one or both sides of a cathode current collector. In some examples, the anode active material layer or the cathode active material layer comprise metal layers arranged adjacent to the current collectors. In other examples, the anode active material layer or the cathode active material layer comprise coatings that are applied to the anode or cathode current collectors. The coatings may include one or more anode or cathode active materials, one or more binders, and one or more conductive fillers.

The anode and cathode current collectors may include foil, wire mesh, or expanded metal. For example, wire mesh current collectors may include wire made of copper (Cu), stainless steel (SS), brass, bronze, zinc (Zn), aluminum (AI), and alloys thereof (e.g., Cu-100 or SS-100). The wire mesh current collectors may be fabricated with wires that are 4 μm to 100 μm thick (e.g., 30 μm). In some examples, the wire mesh current collectors have about 100 to 300 openings per square inch (e.g., 100).

The wires of the wire mesh current collector cross over one another at mesh joints. While the wires are in contact with one another at the mesh joints, the wires are not rigidly connected. As a result, the wire mesh current collector has low strength, stiffness, and/or resistance to deformation which makes it difficult to handle during electrode fabrication. For example, electrode fabrication may include using a roll-to-roll manufacturing process that requires handling of the wire mesh current collector.

The present disclosure relates to methods for increasing the strength and stiffness of wire mesh used as three-dimensional current collectors (3DCCs) in electrodes of battery cells. Voids and/or absence of adequate physical and/or electrical contact between wires that cross at the mesh joints of the wire mesh current collector increases internal resistance of the current collectors. The increased resistance increases heating and/or reduces the performance of anode and/or cathode electrodes using the wire mesh current collectors.

The wire mesh current collectors according to the present disclosure are coated with a metal coating to increase stiffness and reduce resistance. In some examples, the metal coating is applied using electrodeposition. In some examples, the mesh joints of the wire mesh current collectors are further strengthened by annealing the coated wire mesh after the metal coating is applied. Annealing causes the coating to re-melt. The melted coating is drawn further into the mesh joints of the wire mesh current collectors due to capillary force. The melted coating is cooled, solidifies, and more rigidly connects the crossing wires at the mesh joints.

In some examples, the metal coating includes a metal material having a melting point below the melting temperature of the metal of the wires of the wire mesh current collector to allow annealing to optionally be performed after coating. In some examples, the metal coating comprises one or more metals selected from a group consisting of tin (Sn), indium (In), bismuth (Bi), zinc (Zn), nickel (Ni), and alloys thereof. Annealing may be omitted when the metal in the metal coating has a higher melting temperature than the metal of the wires of the wire mesh current collector.

For example, if the wires of the wire mesh current collectors are made of Cu and the metal coating comprises Ni, annealing is not performed since Ni has a higher melting temperature than copper (Cu).

Referring now to FIG. 1, a battery cell 10 includes cathode electrodes 20-1, 20-2, . . . , and 20-C, where C is an integer greater than one. The cathode electrodes 20 include a cathode active material layer 24 arranged on one or both sides of cathode current collectors 26. The battery cell 10 includes anode electrodes 40-1, 40-2, . . . , and 40-A, where A is an integer greater than one. The anode electrodes 40 include an anode active material layer 42 arranged on one or both sides of anode current collectors 46. The cathode electrodes 20, the anode electrodes 40 and the separators 32 are arranged in a predetermined order in an enclosure 50. For example, separators 32 are arranged between the cathode electrodes 20 and the anode electrodes 40. The anode current collector 46 and/or the cathode current collector 26 comprise a coated or coated and annealed wire mesh as described below.

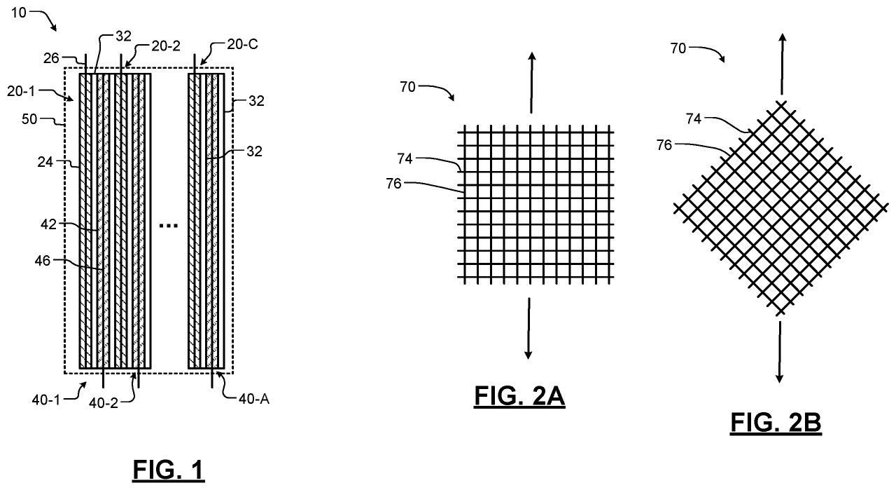

Referring now to FIGS. 2A to 2B, the anode and/or cathode current collectors comprise a wire mesh 70 including a plurality of first wires 74 that are spaced by a predetermined gap and extend parallel to one another in a first direction. The wire mesh 70 includes a plurality of second wires 76 that are spaced by a gap, extend parallel to one another in a second direction that is different than the first direction. The plurality of first wires 74 and the plurality of second wires 76 and are woven above and below one another. In some examples, the first direction and the second direction are transverse, although other angles can be used.

Without coating or coating and annealing, the wire mesh 70 exhibits anisotropy in its mechanical properties. When pulled in the direction in FIG. 2A, the stiffness of an example copper wire mesh is about 22 N/mm with peak load of about 8 N. When pulled in the direction in FIG. 2B, the stiffness is extremely low˜0.06 N/mm with peak load at around 1.5 to 2 N. In addition to low stiffness, electrical contact between the wires of the wire mesh at the mesh joints varies from one location to another. This, in turn, causes variations in the resistance of the wire mesh current collector.

Coating or coating and annealing of the wire mesh current collector as described herein increases the strengthen and stiffness of the wire mesh current collectors. As a result, the wire mesh current collectors have improved manufacturability since they can be used more readily due to their increased strength. The coated or coated and annealed wire mesh current collector also provides increased contact between the plurality of first wires and the plurality of second wires at the mesh joints, which reduces resistance and improves the rate performance of lithium metal anode (LMAs). Furthermore, some of the coatings (e.g., In, Sn, Bi, and Zn) are lithiophilic, which improves lithium adhesion to surfaces of the current collector.

Referring now to FIGS. 3A and 3B, methods 100 and 100′ for coating a wire mesh current collector 110 are shown. In FIG. 3A, the coating and/or annealing process is a roll-to-roll process that is continuous. The wire mesh current collector 110 is immersed in a bath 126 and the metal coating is deposited on the wire mesh current collector 110. In some examples, the bath includes a metal salt. In some examples, the wire mesh current collector 110 is chemically or electrochemically coated. In some examples, negative current is applied to the wire mesh current collector 110 during chemical coating.

The wire mesh current collector 110 passes over a roller 114, into the bath 126, and under a roller 132 located in the bath 126. In some examples, the roller 114 is connected to a power supply that supplies current and the roller 132 and/or the bath 126 are grounded. After passing through the bath 126, the coated wire mesh current collector 134 passes over a roller 136 and under a roller 138 before passing through a heater 144 configured to anneal the wire mesh current collector 110 at a temperature above a melting temperature of the metal used in the coating. While a specific arrangement of rollers is shown, the rollers can be arranged in other configurations.

In FIG. 3B, discrete sections of the wire mesh current collector 110 are immersed in the bath 126 for a predetermined period to chemically coat, deposit, or electroplate the metal coating onto the wire mesh current collector 110. The discrete sections of the wire mesh current collector 110 can be optionally annealed by a heater after coating.

In some examples, the coated wire mesh current collector 134 is heated by heaters 144 at a predetermined temperature greater than a melting temperature of the metal coating to cause the metal coating to re-melt and flow. The melted coating is drawn between the wires of the wire mesh due to capillary force. The wire mesh is allowed to cool and the metal coating re-solidifies. The metal coating resolidifies at the metal joints to rigidly connect the plurality of first wires and the plurality of second wires at the mesh joints. The rigid connection increases physical strength of the wire mesh and reduces the internal resistance of the wire mesh.

In some examples, the coating has a thickness in a range from 1 nm to 1 μm. In some examples, the heater 144 heats the coated wire mesh current collector for a predetermined period in a range from 10 seconds to 30 minutes. In some examples, the heater heats the coated wire mesh current collector for a predetermined period in a range from 1 minute to 10 minutes.

In some examples, the metal in the coating has a melting point below a melting temperature of the material used for the wire mesh current collector 110. In other examples, a coating material (e.g., Ni) having a higher melting temperature than the metal used for the wires of the wire mesh current collector (e.g., Cu) may be used and annealing is omitted.

In some examples, the metal is selected from a group consisting of tin (Sn), indium (In), bismuth (Bi), nickel (Ni), zinc (Zn), and alloys thereof. In some examples, the coated wire mesh current collector 134 may be cooled to allow the coating to solidify prior to annealing. In other examples, the coated wire mesh current collector 134 is not fully cooled after the bath 126 and before annealing by the heater 144.

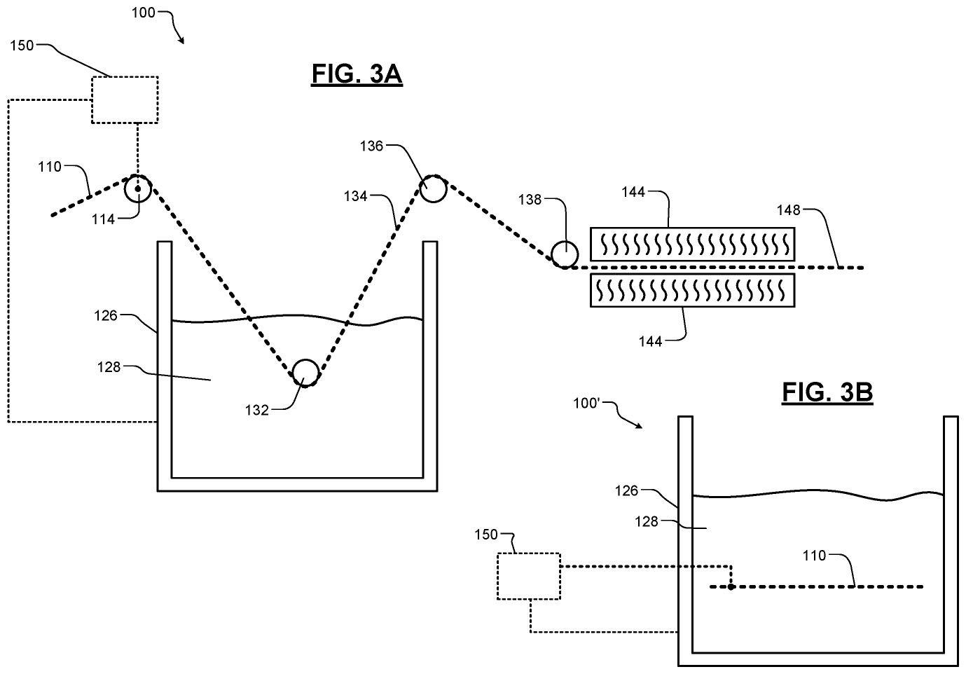

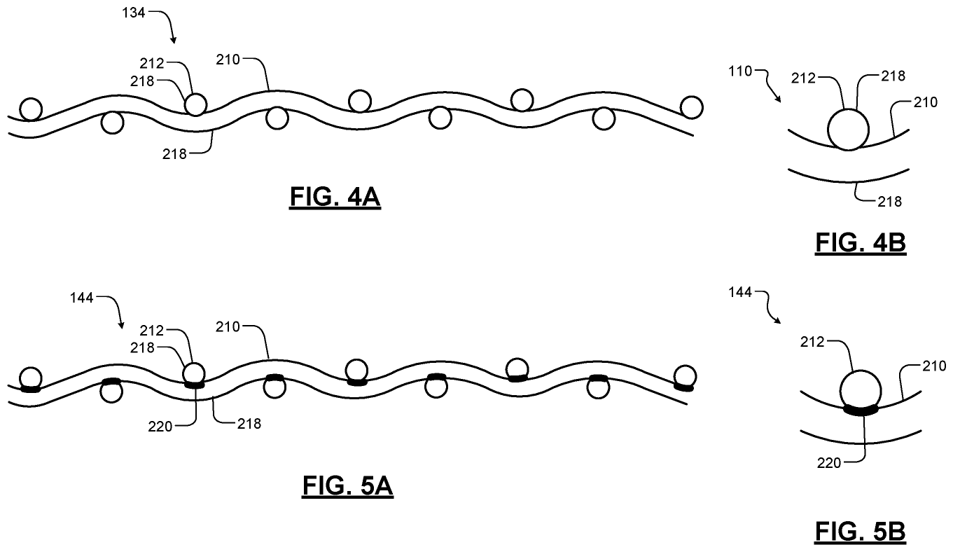

Referring now to FIGS. 4A and 4B, the wire mesh current collector 134 is shown after the metal coating is applied. The wire mesh current collector 134 includes a plurality of first wires 210 extending in a first direction and a plurality of second wires 212 extending in a second direction that is different than the first direction (e.g., transverse). The plurality of first wires 210 and the plurality of second wires 212 of the wire mesh current collector 134 include a coating layer 218.

Referring now to FIGS. 5A and 5B, the wire mesh current collector 148 is shown after coating and annealing. The wire mesh current collector 134 includes the plurality of first wires 210 extending in the first direction and the plurality of second wires 212 extending in the second direction that is different than the first direction (e.g., transverse). The plurality of first wires 210 and the plurality of second wires 212 of the wire mesh current collector 134 include the coating layer 218. After annealing, at least some of the coating layer re-melts and is drawn by capillary force between the plurality of first wires 210 and the plurality of second wires 212 as shown at 220.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

What is claimed is:

1. A method for manufacturing a current collector for an electrode of a battery cell, comprising:
providing a wire mesh current collector including a plurality of first wires and a plurality of second wires that overlap to form a plurality of mesh joints,
wherein a diameter of the plurality of first wires and the plurality of second wires is in a range from 4 μm to 100 μm; and
coating the wire mesh current collector with a metal coating by immersing the wire mesh current collector in a bath including a metal salt.

2. The method of claim 1, wherein the plurality of first wires and the plurality of second wires of the wire mesh current collector are made of one or more metals selected from a group consisting of copper, stainless steel, brass, bronze, zinc, aluminum, and alloys thereof.

3. The method of claim 1, wherein the metal coating includes a metal selected from a group consisting of indium (In), tin (Sn), bismuth (Bi), zinc (Zn), nickel (Ni), and alloys thereof.

4. The method of claim 1, further comprising annealing the wire mesh current collector after coating the wire mesh current collector to increase physical and electrical contact at the plurality of mesh joints.

5. The method of claim 4, wherein the annealing is performed at a temperature greater than a melting temperature of a metal of the metal coating and less than a melting temperature of a metal of the plurality of first wires and the plurality of second wires of the wire mesh current collector.

6. The method of claim 1, further comprising arranging an anode active material layer adjacent to the wire mesh current collector.

7. The method of claim 1, further comprising arranging a cathode active material layer adjacent to the wire mesh current collector.

8. The method of claim 1, further comprising coating the wire mesh current collector with a slurry including anode active material.

9. The method of claim 1, further comprising coating the wire mesh current collector with a slurry including cathode active material.

10. The method of claim 1, wherein the wire mesh current collector is immersed in the bath in discrete sections.

11. The method of claim 1, wherein the wire mesh current collector is continuously immersed in the bath from a roll.

12. A method for manufacturing a current collector for an electrode of a battery cell, comprising:
providing a wire mesh current collector including a plurality of first wires and a plurality of second wires that overlap to form mesh joints,
wherein a diameter of the plurality of first wires and the plurality of second wires is in a range from 4 μm to 100 μm, and
wherein the plurality of first wires and the plurality of second wires of the wire mesh current collector are made of a metal selected from a group consisting of copper, stainless steel, brass, bronze, zinc, aluminum, and alloys thereof;
immersing the wire mesh current collector in a bath including a metal salt to coat the wire mesh current collector,
wherein the metal salt includes a metal selected from a group consisting of indium (In), tin (Sn), bismuth (Bi), zinc (Zn), and alloys thereof; and
annealing the wire mesh current collector after passing the wire mesh current collector through the bath.

13. The method of claim 12, wherein the annealing is performed at a temperature greater than a melting temperature of a metal in the metal salt and less than a melting temperature of the metal used in the wire mesh current collector.

14. The method of claim 12, further comprising arranging an anode active material layer adjacent to the wire mesh current collector.

15. The method of claim 12, further comprising arranging a cathode active material layer adjacent to the wire mesh current collector.

16. The method of claim 12, further comprising coating the wire mesh current collector with a slurry including anode active material.

17. The method of claim 12, further comprising coating the wire mesh current collector with a slurry including cathode active material.

18. The method of claim 12, wherein the wire mesh current collector is immersed in the bath in discrete sections.

19. The method of claim 12, wherein the wire mesh current collector is continuously immersed in the bath from a roll.
